(19) United States
(12) Patent Application Publication
(10) Pub. No.: US 2026/0154604 A1
(43) Pub. Date: Jun. 4, 2026

(54) INSTANCE-LEVEL POISSON PROBABILISTIC MODEL FOR DNA-ENCODED SMALL MOLECULE LIBRARIES

(71) Applicant: GOOGLE LLC, Mountain View, CA (US)

(72) Inventors: Wen TORNG, Cambridge, MA (US); Steven KEARNES, Cambridge, MA (US); Stephan HOYER, San Francisco, CA (US); Kevin MCCLOSKEY, Mountain View, CA (US); Jin XU, Mountain View, CA (US); Jianwen FENG, San Mateo, CA (US); Sharad VIKRAM, San Francisco, CA (US); Matt HOFFMAN, Brooklyn, NY (US); Brian PATTON, Waltham, MA (US)

(21) Appl. No.: 18/705,635

(22) PCT Filed: Dec. 21, 2022
(86) PCT No.: PCT/US2022/053586

§ 371 Date: Apr. 29, 2024

Related U.S. Application Data
(60) Provisional application No. 63/292,840, filed on Dec. 22, 2021.

(51) Int. Cl. G06N 20/00

(52) U.S. Cl. CPC G06N 20/00

(57) ABSTRACT

Provided herein are improved methods for training graph neural networks (GNNs) to predict the binding affinity of novel compounds based on data generated from DNA-encoded library (DEL) experiments. These methods include training the GNN to predict affinity for the target directly and then applying the predicted affinity to a model of the DEL experiment process to generate a predicted DEL read count. The predicted DEL read count can then be compared to an experimentally-observed DEL, read count to generate a loss value. The loss value can then be used to update the GNN as part of a GNN training process. The loss value can be augmented with simulated disynthon data generated from the predicted affinity.

### CROSS-REFERENCE TO RELATED APPLICATION

This application claims priority to U.S. Provisional Patent Application No. 63/292,840, filed Dec. 22, 2021, the contents of which are incorporated by reference.

### BACKGROUND

DNA-encoded chemical libraries (DELs) facilitate the assessment, in a quick, cost-effective manner, of many millions or billions of candidate molecules with respect to their binding affinity to target molecules/epitopes thereof, competitor molecules/sites thereof (e.g., sites related to negative clinical side-effects), or other substances of interest. Such DELs include a vast number of different candidate chemical compounds attached to respective DNA strands, double-strands, etc. that represent the composition (e.g., components and structure) of the chemical compound to which they are attached. The DEL can then be applied to one or more target substances (e.g., a receptor implicated in a disease process). The identity of the candidate compounds within the DEL that exhibited affinity for the target substance(s) can then be observed using DNA sequencing techniques (e.g., PCR, next generation sequencing) to determine the content of the DNA that remained bound to the target substance, thereby generating information about the candidate compounds, which were attached to the remaining DNA, exhibited an affinity for binding to the target substance(s).

### SUMMARY

In a first aspect, a method is provided that exhibits reduced computational cost to train, based on DEL experiment data, models to predict the binding efficacy of candidate molecules for a target, the method including: (i) applying a first graph representing a chemical structure of a first candidate molecule to a predictive model to predict a first affinity of the first candidate molecule for a target, wherein the predictive model comprises a graph convolutional network; (ii) based on the predicted first affinity, determining a first loss value, wherein determining the first loss value comprises: (a) based on the predicted first affinity, determining an expected number of reads of a first DNA associated with the first candidate molecule expected to be observed in a first DNA-encoded library (DEL) experiment, and (b) comparing the determined expected number of reads to an actual number of reads of the first DNA observed in the first DEL experiment; and (iii) based on the first loss value, updating the predictive model.

In a second aspect, a non-transitory computer readable medium is provided having stored thereon instructions that, when executed by one or more processors of a computing device, cause the computing device to perform operations that include: (i) applying a first graph representing a chemical structure of a first candidate molecule to a predictive model to predict a first affinity of the first candidate molecule for a target, wherein the predictive model comprises a graph convolutional network; (ii) based on the predicted first affinity, determining a first loss value, wherein determining the first loss value comprises: (a) based on the predicted first affinity, determining an expected number of reads of a first DNA associated with the first candidate molecule expected to be observed in a first DNA-encoded library (DEL) experiment, and (b) comparing the determined expected number of reads to an actual number of reads of the first DNA observed in the first DEL experiment, and (iii) based on the first loss value, updating the predictive model.

In a third aspect, a system is provided that includes: (i) one or more processing units; and (ii) a non-transitory computer-readable medium. The non-transitory computer-readable medium has stored thereon at least computer-executable instructions that, when executed by the one or more processing units, cause the computing device to perform operations including: (a) applying a first graph representing a chemical structure of a first candidate molecule to a predictive model to predict a first affinity of the first candidate molecule for a target, wherein the predictive model comprises a graph convolutional network; (b) based on the predicted first affinity, determining a first loss value, wherein determining the first loss value comprises: (1) based on the predicted first affinity, determining an expected number of reads of a first DNA associated with the first candidate molecule expected to be observed in a first DNA-encoded library (DEL) experiment, and (2) comparing the determined expected number of reads to an actual number of reads of the first DNA observed in the first DEL experiment; and (c) based on the first loss value, updating the predictive model.

In a fourth aspect, a system is provided that includes: (i) means for applying a first graph representing a chemical structure of a first candidate molecule to a predictive model to predict a first affinity of the first candidate molecule for a target, wherein the predictive model comprises a graph convolutional network; (ii) means for, based on the predicted first affinity, determining a first loss value, wherein determining the first loss value comprises: (a) based on the predicted first affinity, determining an expected number of reads of a first DNA associated with the first candidate molecule expected to be observed in a first DNA-encoded library (DEL) experiment, and (b) comparing the determined expected number of reads to an actual number of reads of the first DNA observed in the first DEL experiment; and (iii) means for, based on the first loss value, updating the predictive model.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

FIG. 1 is a functional block diagram illustrating elements of a computing system or device, according to example embodiments.

FIG. 2 is a flowchart of a method, according to example embodiments.

FIG. 3 is a functional block diagram illustrating aspects of a machine learning algorithm training and inference process, according to example embodiments.

FIG. 4 depicts aspects of a machine learning algorithm training process, according to example embodiments.

FIG. 5 depicts aspects of a machine learning algorithm training process, according to example embodiments.

FIG. 6A depicts experimental results, according to example embodiments.

FIG. 6B depicts experimental results, according to example embodiments.

FIG. 6C depicts experimental results, according to example embodiments.

FIG. 7 depicts experimental results, according to example embodiments.

### DETAILED DESCRIPTION

Example methods and systems are contemplated herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. Further, some of the illustrated elements may be combined or omitted. Yet further, an example embodiment may include elements that are not illustrated in the figures.

### I. OVERVIEW

It is desirable to generate computational models to predict the utility of arbitrary chemical structures (e.g., small molecules) in the treatment of various diseases. Potential drug candidates can then be cheaply and quickly pre-screened by the computational model. Drug candidates that the model predicts are most likely to be effective in treating the disease can then be assessed experimentally. This can reduce the cost and time required to assess a class of candidate molecules by reducing the number of molecules within the class that are experimentally validated. This can include using DNA-encoded chemical libraries (DELs) or other experimental processes to assess the ability of each pre-selected candidate molecule to specifically bind to a target (e.g., a receptor protein implicated in a disease process of interest) while avoiding binding to “anti-targets” (e.g., to receptor protein(s) implicated in common unwanted side effects). Such a model may receive as input a graph that is representative of a candidate molecule's chemical structure (e.g., the model could include a graph neural network) or could receive some other input that is representative of the structure of the candidate molecule and could provide one or more outputs indicative of the efficacy of candidate molecule at binding with a target while avoiding binding to one or more anti-targets, experimental substrates, etc. or some other information that may be relevant to the clinical utility of the molecule.

The magnitude and type of noise present in the count data of a DEL experiment makes it difficult to apply such count data to train a GNN or other predictive model. One solution is to aggregate the count data according to ‘disynthons.’ Each disynthon represents a class of compounds in a DEL experiment (or set of DEL experiments) that all contain the same set of two chemical constituents. The disynthon aggregation may also be segregated according to the order of synthetic addition/modification of each constituent of the compounds, in order to represent some structural information about the compounds. So, for example, a disynthon representing ‘toluene ring’ in a first synthetic step and ‘ketone’ in a third synthetic step could represent compounds synthesized by adding toluene ring-ketone-ketone, toluene ring-aldehyde-ketone, etc. Aggregating counts across individual compound instances according to the disynthon pattern results aggregated disynthon counts whose noise characteristics are more amenable to training a GNN or other predictive chemical model. However, such aggregation does not represent all of the structural information generated by a DEL experiment, and may completely abolish some of the structural information present, e.g., the enrichment of specific compound instances that are only part of non-enriched disynthons.

The methods provided herein facilitate training of GNNs or other predictive chemical models using instance-level DEL count data. This is made possible by interposing a heuristic probabilistic model between the model output and the predicted DEL count data. This allows the affinity of the individual compounds for a target to be predicted directly while also allowing probabilistic training methods (e.g., a Poisson loss function) to be applied to improve the training of the predictive model even in examples where the individual instance count data is noisy. The methods provided herein model the DEL experiment dependence on the instance-level compound binding affinities to generate the predicted count data, which can then be compared to the observed DEL experiment count data to generate a loss function. This loss function can then be used to update the predictive model (e.g., by batching sets of such loss functions, corresponding to sets of difference candidate compounds, into individual model update steps). These methods can include individually modeling the abundance of each compound in the DEL experiment library and updating the individual abundances based on the loss function. In some examples, the set of DEL experiment training data could be re-sampled based on the estimated ‘true’ or ‘original count’ distribution of the individual instance abundances (updated based on the loss function) and the re-sampled training data used to perform additional training of the model.

By allowing this fine-grained instance-level information to be applied to the training of the predictive model, the computational cost of training the predictive model can be reduced. This is because the instance-level experimental data can provide improved data to update the predictive model, thereby reducing the number of update iterations needed to result in convergence of the predictive model. This beneficial effect on the computational cost of model training can also be augmented by allowing the predictive model to predict the binding affinity (or log binding affinity) directly, rather than also modeling the relationship between the binding affinity and the observed counts imposed by the mechanics of the DEL experiment. The present methods can also reduce to memory and storage cost associated with model training by reducing the number of training examples (e.g., individual instance counts and associated candidate chemical structures) needed to train a predictive model to convergence. This reduction can also result in a reduction in the number and extent of DEL experiments/libraries needed to train the predictive model, thereby reducing the time, financial cost, and experimental complexity required to obtain the training data to train such a predictive model.

The methods provided herein also allow for the data from one or more DEL experiments, applying two or more different DEL libraries, to be easily combined to train a single predictive model. This is because the instance-level abundances for each candidate compound can be estimated/trained individually for the different DEL libraries/experiments. Allowing easy combination of data from multiple different DEL libraries allows data from a much richer, broader class of compounds to be applied to train the predictive model, since the synthetic processes/steps can vary significantly from one DEL library to the next. This makes the methods described herein well suited to early-stage hit detection, since a much wider scope of potential compounds can be computationally assessed by a predictive model trained using such a correspondingly wider scope of DEL data. The estimated instance-level abundances for each candidate compound can also be used to re-sample the available training data such that the instance-level data in the training dataset is effectively ‘sampled from’ the estimated ‘true’ or ‘original count’ distribution of the instances.

The predictive model (e.g., GNN) could also be trained to predict a binding affinity of input compounds for multiple different substances. For example, such a trained predictive model could have outputs that are predictive of the binding affinity of an input compound for a target (e.g., a particular protein, enzyme, small molecule, and/or receptor of interest), for an experimental substrate used in the DEL experiments (e.g., a ‘control’ output), for the target when the target has already been exposed to a competitive binding agent (e.g., to control for binding of the input compound to aspects of the target other than a target site), or to some other substance or experimental condition of interest. This can be done to allow the training data to be enriched, e.g., to allow target binding experimental data to be adjusted based on control binding experiments, binding experiments in the presence of a competitive binding agent, etc.

Such methods could also be augmented by the use of disynthon aggregation. For example, a predictive model could alternatingly, or according to some other pattern, be updated using loss functions based on instance-level count predictions and based on disynthon level enrichment classification labels. This could be done, e.g., to improve the rate of training of the predictive model, account for noise in the instance-level count data, etc. This could also be done in order to train a supplemental head of the predictive model to predict such disynthon-level outcomes (e.g., enrichment/non-enrichment classifications), allowing such predicted classifications to be used to rank candidate compounds, to direct hit assessment, to allow for comparison of the present methods to conventional metrics, etc.

Once the predictive model has been trained, it can be used to predict the efficacy of candidate molecules (which may be novel molecules not represented in the training data used to train the model). This can include applying the graph or other representation of the chemical structure of a candidate molecule to the trained model to generate outputs related to the affinity of the candidate molecule to one or more target substances (e.g., a first output related to the binding affinity of the candidate to a target, a second output related to the binding affinity of the candidate to an experimental substrate, a third output related to the binding affinity of the candidate to a first anti-target, and a fourth output related to the binding affinity of the candidate to a second anti-target). These model outputs could then be used to select a subset of candidate molecules for further investigation. Such further investigation could include experimental verification via an additional DEL experiment or some other experiment (e.g., a single-point inhibition experiment, a dose-response experiment), later stages of clinical assessment, or some other targeted investigation.

### II. ILLUSTRATIVE SYSTEMS

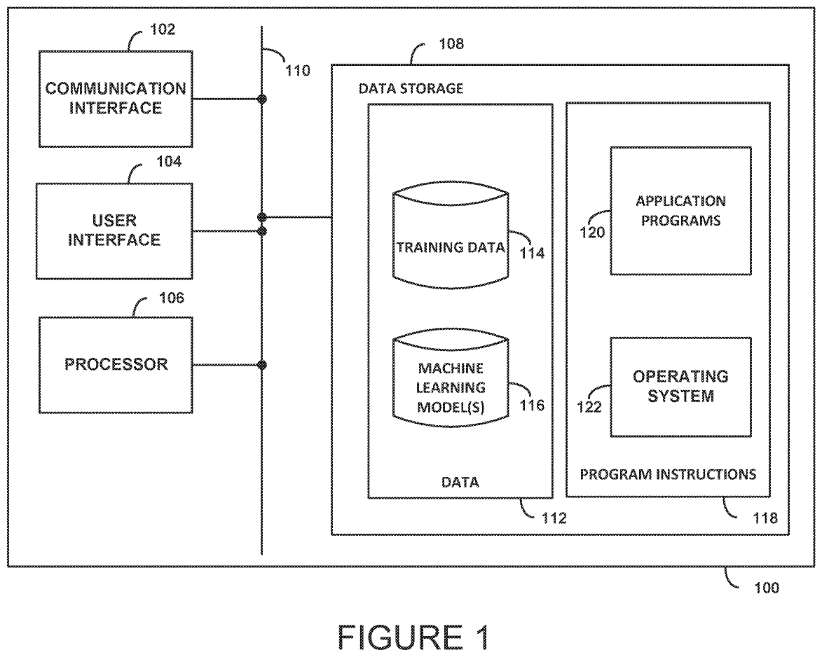

FIG. 1 illustrates an example computing system 100 that may be used to implement the methods described herein. By way of example and without limitation, computing system 100 may be a computer (such as a desktop, notebook, tablet, or handheld computer, a server), elements of a cloud computing system, or some other type of device. It should be understood that computing system 100 may represent a physical computing device such as a server, a particular physical hardware platform on which a machine learning application operates in software, or other combinations of hardware and software that are configured to carry out machine learning functions as described herein. The computing system 100 could be a central system (e.g., a server, elements of a cloud computing system) that is configured to generate and/or receive the outputs of DNA-encoded library experiments (e.g., DNA reads and/or counts) or other information (e.g., information about the binding affinity of a variety of small molecules or other candidate molecules for one or more targets, anti-targets, experimental substrates, or other substances) and to train and/or apply putative molecular structures to a predictive model as described herein.

As shown in FIG. 1, computing system 100 may include a communication interface 102, a user interface 104, a processor 106, and data storage 108, all of which may be communicatively linked together by a system bus, network, or other connection mechanism 110.

Communication interface 102 may function to allow computing system 100 to communicate, using analog or digital modulation of electric, magnetic, electromagnetic, optical, or other signals, with other devices, access networks, and/or transport networks. Thus, communication interface 102 may facilitate circuit-switched and/or packet-switched communication, such as plain old telephone service (POTS) communication and/or Internet protocol (IP) or other packetized communication. For instance, communication interface 102 may include a chipset and antenna arranged for wireless communication with a radio access network or an access point. Also, communication interface 102 may take the form of or include a wireline interface, such as an Ethernet. Universal Serial Bus (USB), or High-Definition Multimedia Interface (HDMI) port. Communication interface 102 may also take the form of or include a wireless interface, such as a Wifi, BLUETOOTH®, global positioning system (GPS), or wide-area wireless interface (e.g., WiMAX or 3GPP Long-Term Evolution (LTE)). However, other forms of physical layer interfaces and other types of standard or proprietary communication protocols may be used over communication interface 102. Furthermore, communication interface 102 may comprise multiple physical communication interfaces (e.g., a Wifi interface, a BLUETOOTH® interface, and a wide-area wireless interface).

In some embodiments, communication interface 102 may function to allow computing system 100 to communicate with other devices, remote servers, access networks, and/or transport networks. For example, communication interface 102 may function to allow computing system 100 to communicate with next-generation sequencers, automated laboratory equipment, or other apparatus configured to perform steps of a DEL experiment or other experiment for generating count data or other binding affinity-related data for candidate molecules against targets or other substances and/or to generate, process, and/or store outputs of such an experiment.

User interface 104 may function to allow computing system 100 to interact with a user or other entity, for example to receive input from and/or to provide output to the user. Thus, user interface 104 may include input components such as a keypad, keyboard, touch-sensitive or presence-sensitive panel, computer mouse, trackball, joystick, microphone, and so on. User interface 104 may also include one or more output components such as a display screen which, for example, may be combined with a presence-sensitive panel. The display screen may be based on CRT, LCD, and/or LED technologies, or other technologies now known or later developed. User interface 104 may also be configured to generate audible output(s), via a speaker, speaker jack, audio output port, audio output device, earphones, and/or other similar devices.

Processor 106 may comprise one or more general purpose processors—e.g., microprocessors—and/or one or more special purpose processors—e.g., digital signal processors (DSPs), graphics processing units (GPUs), floating point units (FPUs), network processors, tensor processing units (TPUs), or application-specific integrated circuits (ASICs). In some instances, special purpose processors may be capable of graph processing, graph transformation, executing machine learning models, or training machine learning models, among other applications or functions. Data storage 108 may include one or more volatile and/or non-volatile storage components, such as magnetic, optical, flash, or organic storage, and may be integrated in whole or in part with processor 106. Data storage 108 may include removable and/or non-removable components.

Processor 106 may be capable of executing program instructions 118 (e.g., compiled or non-compiled program logic and/or machine code) stored in data storage 108 to carry out the various functions described herein. Therefore, data storage 108 may include a non-transitory computer-readable medium, having stored thereon program instructions that, upon execution by computing system 100, cause computing system 100 to carry out any of the methods, processes, or functions disclosed in this specification and/or the accompanying drawings. The execution of program instructions 118 by processor 106 may result in processor 106 using data 112.

By way of example, program instructions 118 may include an operating system 122 (e.g., an operating system kernel, device driver(s), and/or other modules) and one or more application programs 120 (e.g., functions for executing and/or training a machine learning predictive model) installed on computing system 100. Data 112 may include training data (e.g. DNA sequence reads, counts of candidate molecule-specific DNA fragments, other data related to one or more DEL experiments, etc.) 114 and/or machine learning model(s) 116 that may be determined therefrom or obtained in some other manner.

Application programs 120 may communicate with operating system 122 through one or more application programming interfaces (APIs). These APIs may facilitate, for instance, application programs 120 transmitting or receiving information via communication interface 102, receiving and/or displaying information on user interface 104, and so on.

Application programs 120 may take the form of “apps” that could be downloadable to computing system 100 through one or more online application stores or application markets (via, e.g., the communication interface 102). However, application programs can also be installed on computing system 100 in other ways, such as via a web browser or through a physical interface (e.g., a USB port) of the computing system 100.

### III. EXAMPLE METHODS

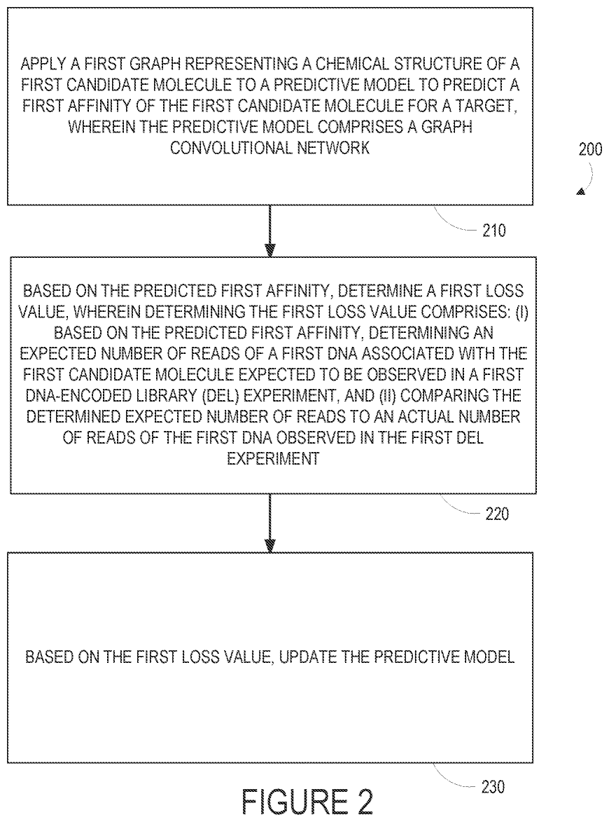

FIG. 2 is a flowchart of an example computer-implemented method 200. The method 200 includes applying a first graph representing a chemical structure of a first candidate molecule to a predictive model to predict a first affinity of the first candidate molecule for a target, wherein the predictive model comprises a graph convolutional network (210). The method 200 additionally includes, based on the predicted first affinity, determining a first loss value, wherein determining the first loss value comprises: (i) based on the predicted first affinity, determining an expected number of reads of a first DNA associated with the first candidate molecule expected to be observed in a first DNA-encoded library (DEL) experiment, and (ii) comparing the determined expected number of reads to an actual number of reads of the first DNA observed in the first DEL experiment (220). The method 200 additionally includes, based on the first loss value, updating the predictive model (230). The method 200 could include additional or alternative features.

### IV. EXAMPLE MACHINE LEARNING MODELS AND TRAINING THEREOF

A machine learning model as described herein may include, but is not limited to: an artificial neural network (e.g., a herein-described neural network, including a graph neural network, convolutional neural network, and/or graph convolutional network, a recurrent neural network, a Bayesian network, a hidden Markov model, a Markov decision process, a logistic regression function, a support vector machine, a suitable statistical machine learning algorithm, and/or a heuristic machine learning system), a support vector machine, a regression tree, an ensemble of regression trees (also referred to as a regression forest), a decision tree, an ensemble of decision trees (also referred to as a decision forest), or some other machine learning model architecture or combination of architectures.

An artificial neural network (ANN) could be configured in a variety of ways. For example, the ANN could include two or more layers, could include units having linear, logarithmic, or otherwise-specified output functions, could include fully or otherwise-connected neurons, could include recurrent and/or feed-forward connections between neurons in different layers, could include filters or other elements to process input information and/or information passing between layers, or could be configured in some other way to facilitate the generation of predicted binding affinities based on input chemical structure graphs.

An ANN could include one or more filters that could be applied to the input and the outputs of such filters could then be applied to the inputs of one or more neurons of the ANN. For example, such an ANN could be or could include a convolutional neural network (CNN). Convolutional neural networks are a variety of ANNs that are configured to facilitate ANN-based classification or other processing based on molecular structure-encoding graphs or other large-dimensional inputs. An ANN can include a graph neural network (GNN. e.g., a graph convolutional network (GCN)) that is configured to receive a graph as an input, e.g., a graph that is indicative of the molecular structure of a chemical compound (e.g., a small molecule that may be a candidate for a therapeutic clinical intervention).

A GCN or other variety of ANN could include multiple convolutional layers (e.g., corresponding to respective different filters and/or features), pooling layers, rectification layers, fully connected layers, or other types of layers. Rectification layers of a GCN apply a rectifying nonlinear function (e.g., a non-saturating activation function, a sigmoid function) to outputs of a higher layer. Fully connected layers of a GCN receive inputs from many or all of the neurons in one or more higher layers of the GCN. The outputs of neurons of one or more fully connected layers (e.g., a final layer of an ANN or GCN) could be used to determine information about portions or motifs of an input molecular structure (e.g., for each of the atoms of an input structure) or for the molecular structure as a whole.

Neurons in a GCN can be organized according to corresponding dimensions of the input structure. For example, where the input is a structure of a small molecule, neurons of the GCN (e.g., of an input layer of the GCN, of a pooling layer of the GCN) could correspond to locations within the structure of the small molecule (e.g., locations of particular atoms, multi-atomic rings or other structures, etc.). Connections between neurons and/or filters in different layers of the GCN could be related to such locations. For example, a neuron in a convolutional layer of the GCN could receive an input that is based on a convolution of a filter with a portion of the input structure, or with a portion of some other layer of the GCN, that is at a location proximate to the location within the overall molecular structure of the portion of the convolutional-layer neuron. In another example, a neuron in a pooling layer of the CNN could receive inputs from neurons, in a layer higher than the pooling layer (e.g., in a convolutional layer, in a higher pooling layer), that have locations that are proximate to the location of the pooling-layer neuron.

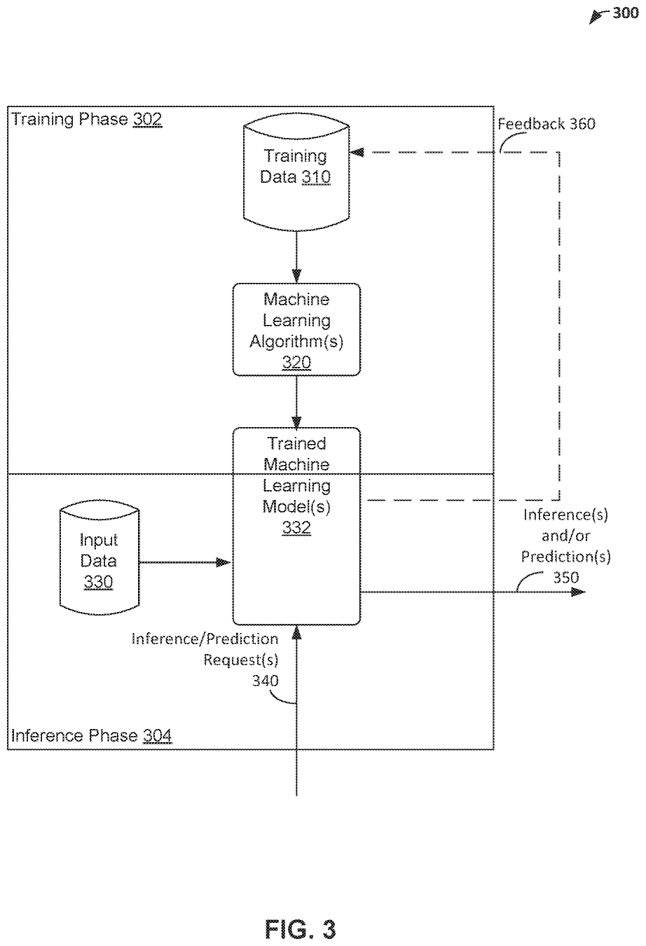

FIG. 3 shows diagram 300 illustrating a training phase 302 and an inference phase 304 of trained machine learning model(s) 332, in accordance with example embodiments. Some machine learning techniques involve training one or more machine learning algorithms, on an input set of training data to recognize patterns in the training data and provide output inferences and/or predictions about (patterns in the) training data. Such output could take the form of experimental data observed that is related to the chemical structure at the input, e.g., DNA sequences, counts, disython-level enrichment scores or classifications, or other DEL experimental data regarding binding affinity of a molecule having the input molecular structure to a target, to a target that has been exposed to a competitor binding substance, to an experimental substrate, to one or more anti-targets, or to some other substance(s) of interest. The resulting trained machine learning algorithm can be termed as a trained machine learning model. For example, FIG. 3 shows training phase 302 where one or more machine learning algorithms 320 are being trained on training data 310 to become trained machine learning model 332. Then, during inference phase 304, trained machine learning model 332 can receive input data 330 (e.g., a graph representing a candidate molecule or candidate disynthon that is part of a hit finding application) and one or more inference/prediction requests 340 (perhaps as part of input data 330) and responsively provide as an output one or more inferences and/or predictions 350 (e.g., predicted binding affinities, enrichment levels, or other information that is indicative of a predicted interaction between an input candidate molecular structure and one or more targets, anti-targets, or other substances of interest).

As such, trained machine learning model(s) 332 can include one or more models of one or more machine learning algorithms 320. Machine learning algorithm(s) 320 may include, but are not limited to: an artificial neural network (e.g., a herein-described graph neural network, convolutional network, and/or graph convolutional network, a recurrent neural network, a Bayesian network, a hidden Markov model, a Markov decision process, a logistic regression function, a support vector machine, a suitable statistical machine learning algorithm, and/or a heuristic machine learning system), a support vector machine, a regression tree, an ensemble of regression trees (also referred to as a regression forest), a decision tree, an ensemble of decision trees (also referred to as a decision forest), or some other machine learning model architecture or combination of architectures. Machine learning algorithm(s) 320 may be supervised or unsupervised, and may implement any suitable combination of online and offline learning.

In some examples, machine learning algorithm(s) 320 and/or trained machine learning model(s) 332 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 320 and/or trained machine learning model(s) 332. In some examples, trained machine learning model(s) 332 can be trained, reside and execute to provide inferences on a particular computing device, and/or otherwise can make inferences for the particular computing device.

During training phase 302, machine learning algorithm(s) 320 can be trained by providing at least training data 310 as training input using unsupervised, supervised, semi-supervised, and/or reinforcement learning techniques. Unsupervised learning involves providing a portion (or all) of training data 310 to machine learning algorithm(s) 320 and machine learning algorithm(s) 320 determining one or more output inferences based on the provided portion (or all) of training data 310. Supervised learning involves providing a portion of training data 310 to machine learning algorithm(s) 320, with machine learning algorithm(s) 30 determining one or more output inferences based on the provided portion of training data 310, and the output inference(s) are either accepted or corrected based on correct results associated with training data 310. In some examples, supervised learning of machine learning algorithm(s) 320 can be governed by a set of rules and/or a set of labels for the training input, and the set of rules and/or set of labels may be used to correct inferences of machine learning algorithm(s) 320.

Semi-supervised learning involves having correct results for part, but not all, of training data 310. During semi-supervised learning, supervised learning is used for a portion of training data 310 having correct results, and unsupervised learning is used for a portion of training data 310 not having correct results. Reinforcement learning involves machine learning algorithm(s) 320 receiving a reward signal regarding a prior inference, where the reward signal can be a numerical value. During reinforcement learning, machine learning algorithm(s) 320 can output an inference and receive a reward signal in response, where machine learning algorithm(s) 320 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 320 and/or trained machine learning model(s) 332 can be trained using other machine learning techniques, including but not limited to, incremental learning and curriculum learning.

During inference phase 304, trained machine learning model(s) 332 can receive input data 330 (e.g., input graphs indicative of the chemical structure of candidate small molecule drugs) and generate and output one or more corresponding inferences and/or predictions 350 about input data 330 (e.g., predicted binding affinities, enrichment values, or other information related to the predicted interaction between a molecule having the structure of the input and a target, anti-target, experimental substrate, or other substance of interest). As such, input data 330 can be used as an input to trained machine learning model(s) 332 for providing corresponding inference(s) and/or prediction(s) 350. For example, trained machine learning model(s) 332 can generate inference(s) and/or prediction(s) 350 in response to one or more inference/prediction requests 340. In some examples, trained machine learning model(s) 332 can be executed by a portion of other software. For example, trained machine learning model(s) 332 can be executed by an inference or prediction daemon to be readily available to provide inferences and/or predictions upon request.

As described above, training a graph neural network, graph convolutional network, or other variety of machine learning model (e.g., 332) can include applying training data (e.g., 310) that may include examples of inputs to the model along with corresponding observed ‘true’ outputs. For example, the inputs in such training data could include the identity and/or chemical structure of candidate molecules, and the outputs could be counts of DNA that correspond to the candidate molecules, observed as part of one or more DEL experiments. Training the predictive model could include comparing the predicted and observed/‘true’ counts according to a loss function (e.g., a Poisson loss or some other probabilistic loss function) and using the output of the loss function to update the predictive model. This could include using backpropagation to pass the determined loss function output back through the layers of the predictive model and/or any invertible functions used to convert the output(s) of the predictive model (e.g., binding affinities of an input compound for a target substance, experimental substrate, etc.) into predicted DNA counts.

As noted above, the magnitude and structure of the noise present in DEL experiment DNA counts makes it difficult to use such output data to predict binding affinity (or other information of interest) about candidate compounds individually and directly. The methods described herein facilitate such training by applying binding affinities predicted by the predictive model to a heuristic model of the DEL experiment in order to predict the DNA counts observed in the DEL experiment. This can include modeling and estimating the effect of differing initial abundances of the different candidate molecules in each DEL library in order to account for the effect of such differences on the observed DNA counts. A Poisson loss function or other probabilistic loss function is then used to compare the predicted and observed DNA counts, generating a feedback signal that can then be used to update the predictive model and/or other aspects of the training and predictive process (e.g., to update estimated abundances of individual candidate molecules in the DEL experimental library(s)).

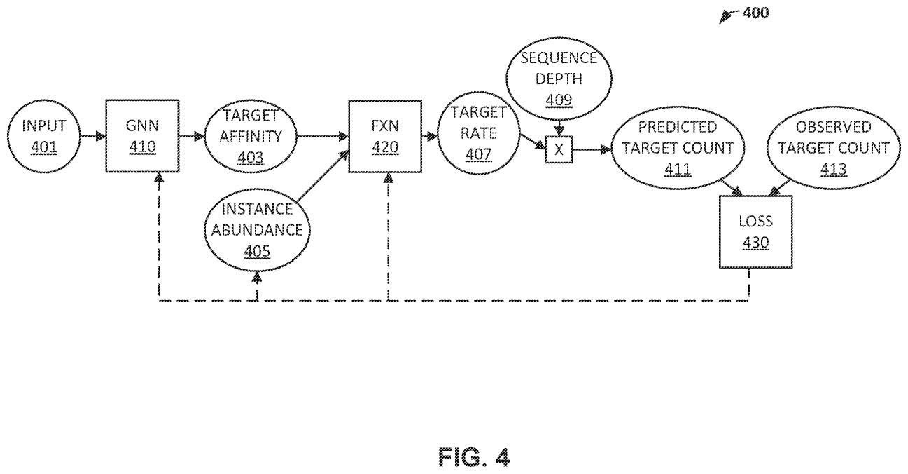

FIG. 4 illustrates aspects of such a model training process 400. An input graph 401 that represents the chemical structure of a candidate molecule is applied to the predictive model 410, which includes a graph convolutional network or other variety of graph neural network, to generate a predicted binding affinity 403 of the candidate molecule for a target of interest (e.g., a particular enzyme, protein, receptor, binding site of a receptor). The predicted target affinity 403 is then applied to a heuristic function 420 that models the DEL experimental process to translate the predicted affinity 403 of the candidate molecule into a predicted target sequencing rate 407 of the DNA in the DEL experiment that is associated with the candidate molecule. As shown, this heuristic function 420 can account for a variety of factors relevant to the DEL experiment process, including the abundance 405 of the candidate molecule (and associated DNA) in the DNA library used in the DEL experiment. The predicted target sequencing rate 407 is then multiplied by the sequencing depth 409 of the DEL experiment to generate the predicted target count 411 of DNA associated with the candidate molecule detected via the DEL experiment. This predicted count 411 is then compared with the observed count 413 (or ‘true’ count) of DNA associated with the candidate molecule observed as part of the DEL experiment. The predicted 411 and observed 413 counts are then compared via a loss function 430 (e.g., a Poisson loss function or some other probabilistic loss function).

The output of the loss function can then be used to update the predictive model 410 or other aspects of the model training process 400, e.g., to update the estimated abundance 405 of the candidate molecule in the DEL experiment or parameters of the heuristic function 420 (e.g., global offset parameters, a concentration of the target or other substance to which the candidate molecules bind). This update process is indicated by the dashed lines in FIG. 4. Note that other aspects of the model training process 400 could be additionally or alternatively be updated based on the output of the loss function 430, e.g., parameters of the loss function itself, the sequencing depth 409.

Note further that, where data from multiple different DEL experiments and/or libraries (e.g., applying respective different libraries of DNA-linked candidate molecules) is used to train the predictive model 410, aspects of the model training process 400 could be trained on a per-DEL-experiment and/or per-DEL-library basis. For example, the sequencing depth, instance abundance for the same candidate molecule and/or associated DNA, target concentration (or concentration of substrate matrix or some other binding substance of interest), or some other variable or aspect represented in the model training process 400 could vary between DEL experiments and/or between DEL libraries applied in one or more such DEL experiments. In such examples, aspects of the model training process 400 that are DEL-experiment-specific and/or DEL-library-specific (e.g., instance abundances, sequencing depths, etc.) could be updated based only on loss function 430 outputs corresponding to the appropriate DEL experiment and/or library.

So, for example, a first loss function output generated based on data from a first DEL library in a first DEL experiment could be used to update the predictive model 410 along with the estimated sequencing depth 409, estimated target concentration, and estimated candidate molecule instance abundance 405 for the first DEL library in the first DEL experiment while a second loss function output generated based on data from a second DEL experiment, or from a second DEL library also used in the first DEL experiment, could be used to update the predictive model 410 along with the estimated sequencing depth 409, estimated target concentration, and estimated candidate molecule instance abundance 405 for the second DEL experiment and/or second DEL library. As noted above, this ability to train based on data from multiple different DEL experiments and/or libraries allows for the predictive model to be improved by applying training data that represents a much wider variety of candidate compounds (e.g., due to the different DEL candidate molecule libraries being constrained by respective different synthetic processes and pathways). Accordingly, a predictive model trained using the methods described herein can be of increased utility, especially in early-stage hit finding where the class of molecule needed to bind to a novel target is unknown.

A variety of functions could be applied in the heuristic function 420 to predict a target sequencing rate 407 for a candidate molecule based on the target binding affinity 403 predicted, for the candidate molecule, by the predictive model 410. Note that the exact form of the heuristic function 420 may be modified, mutatis mutandis, to account for variations in the format of the predicted target binding affinity 403. For example, the predictive model 410 could be trained to output the log of the binding affinity for the target or to predict the binding affinity for the target directly. The exact form of the heuristic function 420 can be adapted to whichever choice is made. e.g., by including an exponential function, a logarithm, or other transforming functions.

An example heuristic function 420 is:

$${f}_{i} = \frac{1}{( 1 + {e}^{x} {i}^{- T} )} ; p ( {x}_{i} ) = \frac{{f}_{i} {A}_{i}}{{\sum }_{j} {f}_{j} {A}_{j}} \qquad Equation 1$$

where p(xᵢ) is the predicted sequencing rate of instances of DNA associated with candidate molecule i, xᵢ is the log of the binding affinity of candidate molecule i for the target, T is a variable (which can be learned and/or observed) that approximates the concentration of the target in the DEL experiment, Aᵢ is the baseline, pre-experiment abundance of instances of DNA associated with candidate molecule i in the DEL experiment, and the subscript j represents the set of all candidate molecules in the DEL experiment.

This example heuristic function 420 can be refactored into:

$$p ( {x}_{i} ) = \frac{{e}^{( {α}_{{L}_{i}} + c )}}{1 + {e}^{x} {i}^{- T}} \qquad Equation 2$$

where a_{L}_{ᵢ} is a learnable term related to the pre-experiment abundance of instances of DNA associated with candidate molecule i in library Lᵢ the DEL experiment and c is a learnable term that represents the sum ΣⱼfⱼAⱼ in Equation 1. As noted above, these functions can be adapted to permit multiple sets of DEL experiment data and/or data from multiple DEL libraries in a single DEL experiment to be used to train a predictive model by setting some or all of the learnable parameters (e.g., a_{L}_{ᵢ}, c, and/or T) to be learnable on a per-DEL-experiment and/or per-DEL-library basis.

The model training process 400 depicted in FIG. 4 can be augmented and/or modified in a variety of ways. For example, the predictive model 410 could be expanded to predict the affinity of input candidate molecules for an experimental substrate material (e.g., the material of microbeads or other components used to perform a DEL experiment and to which candidate molecules might bind in addition or alternatively to binding to a target substance), to non-target aspects of a target substance (e.g., to portions of a receptor other than the receptor's binding site). Additionally or alternatively, a hybrid training process could be employed that uses aggregated disynthon data to train the predictive model in addition to individual per-candidate-molecule instance counts. These additions could be done to improve the quality of the predictive model (e.g., by permitting additional training data from control experiments to be applied and/or lower-noise disynthon-level label or enrichment data), to allow the predictive model to predict additional information about candidate molecules (e.g., whether the candidate molecule is likely to bind to a target site or to some other undesired site on a target substance), or to provide some other benefit.

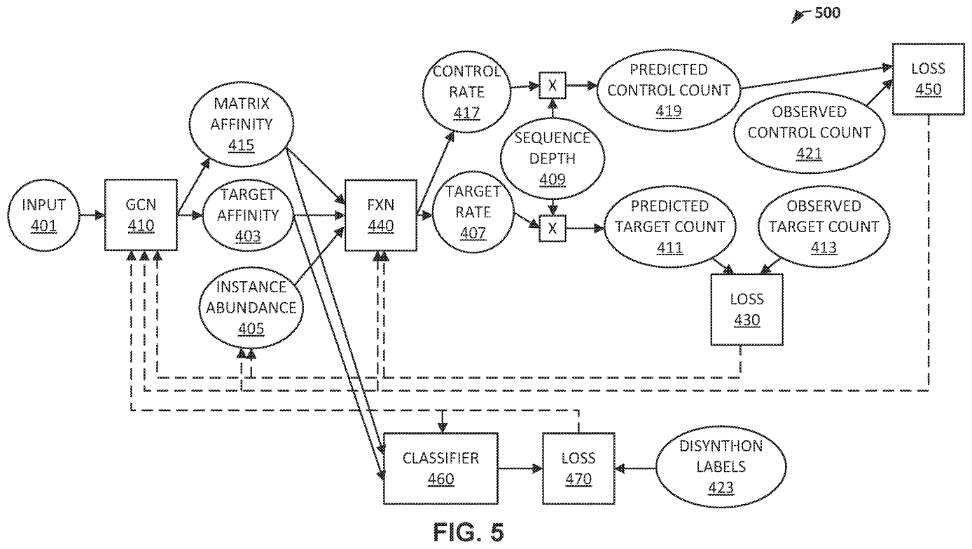

FIG. 5 depicts an example model training process 500 that has been augmented in these ways. The predictive model 410 additionally generates a predicted binding affinity 415 of the candidate molecule for an experimental substrate matrix material (e.g., microbeads to which the target substance is bound, linking proteins or other substances used to bind the target substance to such a microbead substrate). The heuristic function 440 has been updated to output both predicted target sequencing rate 407 of the DNA in the DEL experiment that is associated with the candidate molecule in a target-positive portion of the DEL experiment as well as a predicted control sequencing rate 417 of the DNA in the DEL experiment that is associated with the candidate molecule in a target-negative control portion of the DEL experiment (i.e., an experimental-substrate-matrix-only portion of the DEL experiment). The predicted control sequencing rate 417 is then multiplied by the sequencing depth 409 of the DEL experiment to generate the predicted control count 419 of DNA associated with the candidate molecule detected via the control DEL experiment. This predicted count 419 is then compared with the observed count 421 (or ‘true’ count) of DNA associated with the candidate molecule observed as part of the control DEL experiment. The predicted 419 and observed 421 counts are then compared via a loss function 450 (e.g., a Poisson loss function or some other probabilistic loss function), which may be the same or different from the loss function 430 applied to the predicted and observed target-positive counts, to generate an additional loss value that may be applied to update the predictive model 410 and/or other aspects of the model training process 500.

The model training process 500 and predictive model 410 could be further expanded in this manner to account for the prediction of additional predicted binding affinities and corresponding additional DEL experiment portions. For example, the predictive model 410 could be expanded to predict a binding affinity for non-target portions of a target substance (e.g., for portions of a receptor other than a target binding site thereof), which may be referred to as a non-target-site affinity. This expansion could be facilitated by the DEL experiment including an addition portion wherein binding of candidate molecules to instances of the target that have already been exposed to a known competitor substance with a highly specific binding affinity for the target site of the target molecule.

The heuristic function 440 of such an expanded model training process 500 could be modified to account for such expansions in the number of predicted affinities and corresponding increase in the number of sequencing rates to predict (e.g., to predict a first control sequencing rate for a target-negative portion of the DEL experiment and to predict a second control sequencing rate for a target-positive portion of the DEL experiment wherein the target substance is first exposed to a known competitor substance with a highly specific binding affinity for the target site of the target molecule. This could be done by, for example, predicting the control sequencing rate 417 by applying the predicted substrate binding affinity 415 to equation 2 without modification. The target sequencing rate 407 could then be predicted by applying a version of the predicted target binding affinity 403 that has been corrected to account for the nonspecific binding of the candidate molecule to the experimental substrate, which would affect the observed target count 413 in the target-positive portion of the DEL experiment. Following training of the predictive model 410, such a corrected target affinity could be used to rank potential candidate molecules.

This could be done by correcting the predicted target affinity 403 based on the predicted substrate affinity 415. For example, the predicted substrate affinity 415 could be subtracted from the predicted target affinity 403 in log space (i.e., the corrected target affinity is exp(log(predicted target affinity 403)-log(predicted substrate affinity 415))) to generate the corrected target affinity, which would then be applied to, e.g., equation 2 to generate the predicted target sequencing rate 407. Where the predictive model 410 also predicts additional affinities (e.g., affinity for non-target portions of the target substance), these additional affinities could be used to correct the target affinity and/or be themselves corrected before being used to predict sequencing rates. For example, the sequencing rate for a target-positive, competitor-positive DEL experiment could be predicted by correcting a predicted non-target-site affinity using the substrate affinity as described above before application to, e.g., equation 2. Additionally or alternatively, the target affinity could be corrected using both the substrate affinity and non-target-site affinity before application, e.g., to equation 2. Such a correction could include subtracting the greater of the substrate affinity or the non-target-site affinity from the target affinity in log space.

Note that, while a single sequencing depth 409 and instance abundance 405 are illustrated as being applied to both the control and non-control portions of DEL experiment data, separate values for one or both of these variables could be used as appropriate (e.g., where the pre-experiment library abundances and/or sequencing depth differ between the control/target-negative and non-control/target-positive portions of a DEL experiment.

The model training process 500 has also been expanded to permit disynthon-aggregated data to be used to train the predictive model 410. An input 401 representing a disynthon is applied to the predictive model 410 to generate predicted affinities 403, 415. The predicted affinities are then applied to a classifier 460 to generate a label, one or more class probabilities, or other class-related predictive value(s) for the applied disynthon. The predicted label is then compared, using a loss function 470, to a disynthon label 423 for the applied disynthon to generate a loss value that can then be used to update the predictive model 410 and/or the classifier 460 itself (e.g., threshold levels, linear weights of one or more connected layers of the classifier 460, etc.). The addition of disynthon-level training data could permit the predictive model 410 to be improved by the addition of lower-noise training data to train the predictive model 410. Such disynthon-level training data could be applied alternatingly with ‘instance-level,’ per-candidate-molecule training data (e.g., instance-level DNA counts), batched together with instance-level training data, or used according to some other pattern or scheme in combination with instance-level DEL experiment data to train the predictive model 410.

The classifier 460 could include an artificial neural network, a fully-connected linear layer, one or more nonlinear output functions and/or thresholds, or some other element(s) or combination of elements to generate, from affinity values predicted by the predictive model 410, one or more output labels for an applied disynthon. For example, a single label representing whether the disynthon is enriched (vs. non-enriched) could be predicted. Multiple labels could be predicted, e.g., in line with a conventional drug discovery prediction using disynthon-aggregated count data. For example, the classifier 460 could output labels representing, respectively, the applied candidate disynthon being a “non-hit,” a “matrix binder,” a “promiscuous binder,” a “non-competitive hit,” and/or a “competitive hit.”

A trained predictive model 410 and classifier 460 can also be used to rank candidate models for further assessment, e.g., further, targeted DEL experiments, a single-point inhibition experiment, a dose-response experiment) later stages of clinical assessment, or some other targeted investigation. Additionally or alternatively, the trained predictive model 410 and classifier 460 could be used to compare the accuracy, specificity, or other metrics of the present model training methods to conventional methods (e.g., disynthon-based methods).

### V. EXPERIMENTAL DATA

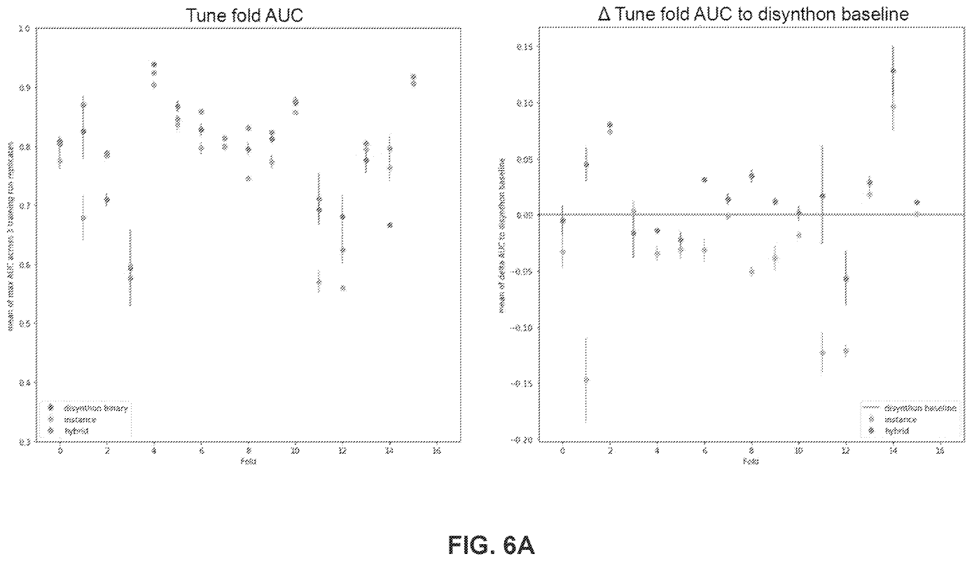

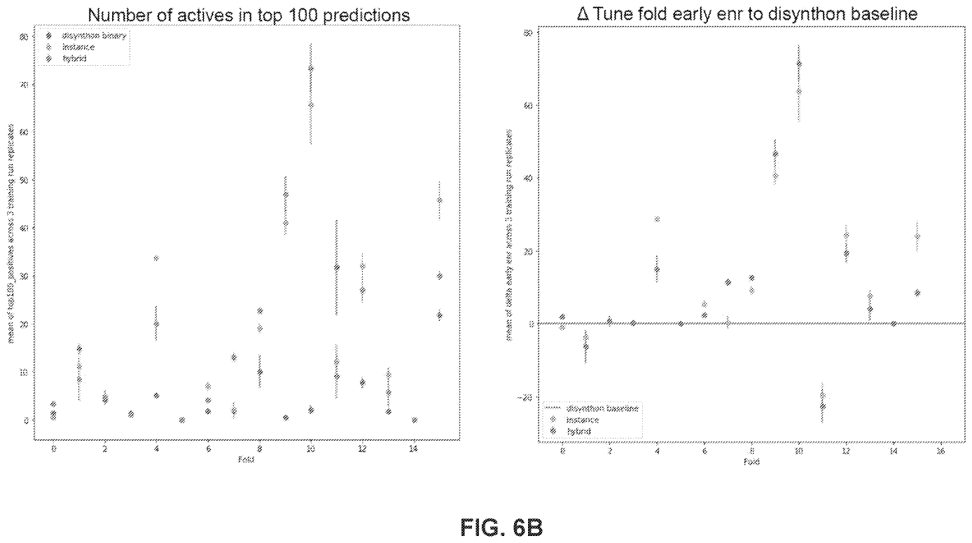

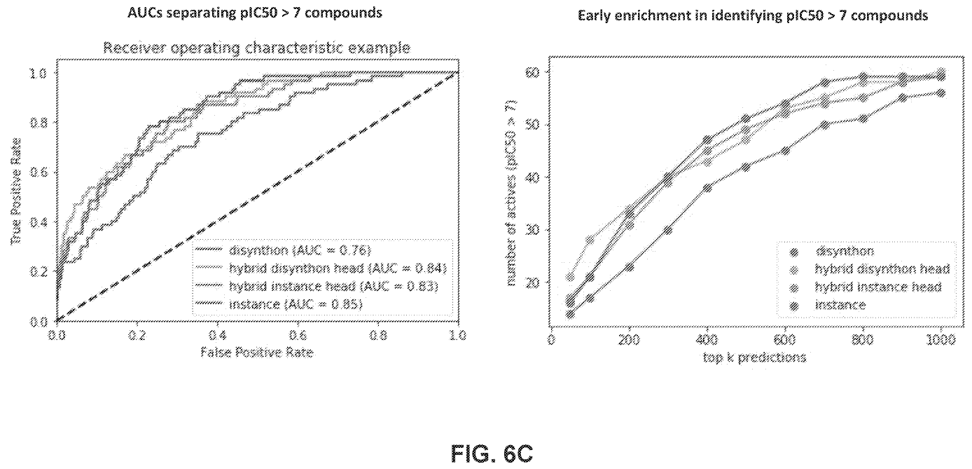

The methods described herein were used to train predictive models using disynthon-only training data, instance-only training data (e.g., as in FIG. 4), and hybrid training using both instance-level and disynthon-level training data (e.g., as in FIG. 5). The results, in terms of the area under the receiver operating characteristic curve (AUC) for each model in assessing known hits vs. non-hits when using disynthon inputs evaluated against disynthon label outputs, are shown in FIG. 6A. FIG. 6A shows the mean of the maximum AUC across three training run replicates for sixteen different mutually-exclusive folds of the training data (with each fold generated by grouping together data from structurally similar DEL libraries). Cross validation was applied by holding fold i and fold i+1 out as validation and test folds, respectively, and using the remaining 14 folds for training. Each fold model was trained with 3 independent replicates to access model variability. Iterating i from 0-15 resulted in the 16 different fold models depicted in FIGS. 6A and 6B, each with 3 replicates.

The overall mean AUC for disynthon-only training was 0.785, for instance-only training was 0.759, and for hybrid training was 0.804. As shown, the hybrid model generally outperformed the disynthon-only model.

The hybrid and instance-only training generally outperformed the disynthon-only training with respect to early enrichment of the top-performing candidate molecules. This is depicted in FIG. 6B, which depicts the mean of the top 100 ‘positive’ candidates predicted by each method across three training run replicates for each of a number of different folds of the training data (with each fold generated by grouping together data from structurally similar DEL libraries). This ‘early enrichment’ for disynthon-only training on binary labels was a factor of 6.52, for instance-only training a factor of 17.77, and for hybrid training was a factor of 16.83. As shown, the hybrid and instance-only models generally outperformed the disynthon-only model.

The performance of these different methods was also evaluated with respect to 1500 compounds for which half maximal inhibitory concentration (“IC50”) measurements against Estrogen Receptor alpha (“ERa”) were available, 60 of which had a plC50 values greater than 7 (IC50=−log 10(IC50), higher pIC50 values correspond to higher potency in binding to ERa). The different methods (instance-only, disynthon-only, and hybrid) were assessed with respect to their ability to separate the pIC50>7 compounds from the remainder of the compounds. The ROC curves, and corresponding AUC values, for each method are shown in FIG. 6C.

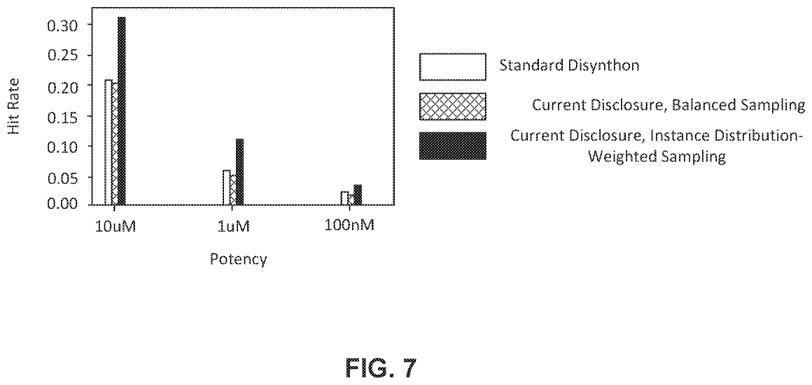

The methods described herein were also evaluated, relative to previous disynthon-only predictive methods, by experimentally validating the hit rates of compounds selected via those methods. FIG. 7 depicts the experimentally-validated hit rates of sets of approximately 200 high-scoring and diverse compounds selected via three different methods, evaluated at three different levels of potency (10 uM, 1 uM, and 100 nM). The models used to generate the three different sets of 200 predicted hits were:
1) a traditional disynthon model, trained using disynthon-level DEL experiment count data selected using an over-sampling strategy to over-sample from minority classes and folds to ensure that, within each mini-batch of training, there are an equal number of examples from different classes and folds (“Standard Disynthon,” of the 200 selected via this method, 182 were delivered and experimentally tested);
2) the instance-level model as described herein, trained using instance-level DEL experiment count data, with the training dataset equally sampled from mini-batches of the experimental data divided into low, medium, and high count bins such that mini-batches of training data of high-count instances are upsampled and mini-batches of training data of low-count instances are downsampled to approximate the training effects of the sampling scheme used in disynthon model training (“Current Disclosure, Balanced Sampling,” of the 200 selected via this method, 183 were delivered and experimentally tested); and
3) the instance-level model as described herein, trained using instance-level DEL experiment count data, with the training dataset sampled from the experimental data by weighting the training dataset so as to effectively sample from the estimated ‘true’ or ‘original count’ distribution of the instance abundances (“Current Disclosure, Instance Distribution-Weighted Sampling,” of the 200 selected via this method, 179 were delivered and experimentally tested).

As shown in FIG. 7, the models and model training methods described herein, when using training data weighted to comport with the estimated ‘true’ distribution of the instances, achieved (i) a statistically significantly higher hit rate at the 10 uM cutoff than the traditional disynthon model, and (ii) twice the hit rate of the traditional disynthon model at the 1 uM cutoff.

### VI. CONCLUSION

The particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

1. A computer-implemented method exhibiting reduced computational cost to train, based on DEL experiment data, models to predict the binding efficacy of candidate molecules for a target, the method comprising:
applying a first graph representing a chemical structure of a first candidate molecule to a predictive model to predict a first affinity of the first candidate molecule for a target, wherein the predictive model comprises a graph convolutional network;
based on the predicted first affinity, determining a first loss value, wherein determining the first loss value comprises: (i) based on the predicted first affinity, determining an expected number of reads of a first DNA associated with the first candidate molecule expected to be observed in a first DNA-encoded library (DEL) experiment, and (ii) comparing the determined expected number of reads to an actual number of reads of the first DNA observed in the first DEL experiment; and
based on the first loss value, updating the predictive model.

2. The computer-implemented method of claim 1, wherein determining the first loss value comprises determining a Poisson loss based on the comparison of the determined expected number of reads of the first DNA to the actual number of reads of the first DNA observed in the first DEL experiment.

3. The computer-implemented method of claim 1, wherein determining the expected number of reads of the first DNA based on the predicted first affinity comprises determining the expected number of reads of the first DNA based on the predicted first affinity and an estimated abundance of the first candidate molecule in the first DEL experiment.

4. The computer-implemented method of claim 3, further comprising:
based on the first loss value, updating the estimated abundance of the first candidate molecule in the first DEL experiment.

5. The computer-implemented method of claim 3, wherein determining the expected number of reads of the first DNA based on the predicted first affinity and an estimated abundance of the first candidate molecule in the first DEL experiment comprises determining a ratio of a first exponential function of the estimated abundance of the first candidate molecule in the first DEL experiment divided by a sum of one and a second exponential function of the predicted first affinity.

6. The computer-implemented method of claim 5, wherein the first exponential function of the estimated abundance of the first candidate molecule in the first DEL experiment is an exponential function of a sum of the estimated abundance of the first candidate molecule in the first DEL experiment and a global offset term, and wherein the method further comprises:
based on the first loss value, updating the global offset term.

7. The computer-implemented method any of claim 5, wherein the second exponential function of the predicted first affinity is an exponential function of a sum of the first predicted affinity and a predicted concentration of the target in the first DEL experiment, and wherein the method further comprises:
based on the first loss value, updating the predicted concentration of the target in the first DEL experiment.

8. The computer-implemented method of claim 1, wherein determining the expected number of reads of the first DNA based on the predicted first affinity comprises determining the expected number of reads of the first DNA based on the predicted first affinity and an estimated abundance of the first candidate molecule in the first DEL experiment, and wherein the method further comprises:
based on the first loss value, updating the estimated abundance of the first candidate molecule in the first DEL experiment;
applying a second graph representing a chemical structure of a second candidate molecule to the predictive model to predict a second affinity of the second candidate molecule for the target;
based on the predicted second affinity and an estimated abundance of the second candidate molecule in a second DEL experiment, determining a second expected number of reads of a second DNA associated with the second candidate molecule expected to be observed in the second DEL experiment;
comparing the determined second expected number of reads to an actual number of reads of the second DNA observed in the second DEL experiment to determine a second loss value for the second candidate molecule; and
based on the second loss value, updating the predictive model.

9. The computer-implemented method of claim 8, further comprising:
based on the second loss value, updating the estimated abundance of the second candidate molecule in the second DEL experiment;
based on the updated estimated abundance the of the first candidate molecule in the first DEL experiment and the updated estimated abundance of the second candidate molecule in the second DEL experiment, re-sampling training examples from the first DEL experiment and the second DEL experiment to generate an updated training dataset that is weighted such that a representation of the first candidate molecule in the updated training dataset reflects the updated estimated abundance the of the first candidate molecule in the first DEL experiment and such that a representation of the second candidate molecule in the updated training dataset reflects the updated estimated abundance of the second candidate molecule in the second DEL experiment; and
performing additional updates of the predictive model by training the predictive model using the updated training dataset.

10. The computer-implemented method of claim 1, further comprising:
applying the first graph representing the chemical structure of the first candidate molecule to the predictive model to predict a third affinity of the candidate molecule for an experimental substrate; and
based on the predicted third affinity, determining a third loss value for the first candidate molecule, wherein determining the third loss value comprises: (i) based on the predicted third affinity, determining an expected number of reads of the first DNA associated with the first candidate molecule expected to be observed in a control portion of the first DEL experiment, and (ii) comparing the determined expected number of reads of the first DNA in the control portion of the first DEL experiment to an actual number of reads of the first DNA observed in the control portion of the first DEL experiment;
wherein updating the predictive model based on the first loss value comprises updating the predictive model based on the first loss value and the third loss value.

11. The computer-implemented method of claim 10, further comprising:
prior to determining the first loss value, correcting the predicted first affinity based on the predicted third affinity.

12. The computer-implemented method of claim 1, further comprising:
applying the first graph representing the chemical structure of the first candidate molecule to the predictive model to predict a fourth affinity of the candidate molecule for the target in the presence of a competitive binding substance for the target; and
based on the predicted fourth affinity, determining a fourth loss value for the first candidate molecule, wherein determining the fourth loss value comprises: (i) based on the predicted fourth affinity, determining an expected number of reads of the first DNA associated with the first candidate molecule expected to be observed in a competitive binding portion of the first DEL experiment, and (ii) comparing the determined expected number of reads of the first DNA in the competitive binding portion of the first DEL experiment to an actual number of reads of the first DNA observed in the competitive binding portion of the first DEL experiment;
wherein updating the predictive model based on the first loss value comprises updating the predictive model based on the first loss value and the fourth loss value.

13. The computer-implemented method of claim 12, further comprising:
prior to determining the first loss value, correcting the predicted first affinity based on the predicted fourth affinity.

14. The computer-implemented method of claim 1, further comprising:
applying a first graph representing a chemical structure of a first disynthon to the predictive model to predict a fifth affinity of the first disynthon for the target;
based on the predicted fifth affinity, determining a fifth loss value, wherein determining the fifth loss value comprises: (i) applying the predicted fifth affinity to a classifier to generate an expected class for the first disynthon with respect to the first disynthon's affinity for the target, and (ii) comparing the determined expected class for the first disynthon to an observed class of the disynthon determined from the first DEL experiment; and
based on the fifth loss value, updating the predictive model and the classifier.

15. The computer-implemented method of claim 14, wherein generating an expected class for the first disynthon comprises generating a binary classifier that is indicative of whether compounds corresponding to the first disynthon are likely to be enriched by exposure to the target.

16. A computing device comprising:
one or more processors, wherein the one or more processors are configured to perform operations comprising:
applying a first graph representing a chemical structure of a first candidate molecule to a predictive model to predict a first affinity of the first candidate molecule for a target, wherein the predictive model comprises a graph convolutional network;
based on the predicted first affinity, determining a first loss value, wherein determining the first loss value comprises: (i) based on the predicted first affinity, determining an expected number of reads of a first DNA associated with the first candidate molecule expected to be observed in a first DNA-encoded library (DEL) experiment, and (ii) comparing the determined expected number of reads to an actual number of reads of the first DNA observed in the first DEL experiment; and
based on the first loss value, updating the predictive model.

17. An article of manufacture including a non-transitory computer-readable medium, having stored thereon program instructions that, upon execution by a computing device, cause the computing device to perform operations comprising:
applying a first graph representing a chemical structure of a first candidate molecule to a predictive model to predict a first affinity of the first candidate molecule for a target, wherein the predictive model comprises a graph convolutional network;
based on the predicted first affinity, determining a first loss value, wherein determining the first loss value comprises: (i) based on the predicted first affinity, determining an expected number of reads of a first DNA associated with the first candidate molecule expected to be observed in a first DNA-encoded library (DEL) experiment, and (ii) comparing the determined expected number of reads to an actual number of reads of the first DNA observed in the first DEL experiment; and
based on the first loss value, updating the predictive model.

18. The article of manufacture of claim 17, wherein determining the first loss value comprises determining a Poisson loss based on the comparison of the determined expected number of reads of the first DNA to the actual number of reads of the first DNA observed in the first DEL experiment and wherein determining the expected number of reads of the first DNA based on the predicted first affinity comprises determining the expected number of reads of the first DNA based on the predicted first affinity and an estimated abundance of the first candidate molecule in the first DEL experiment.

19. The article of manufacture of claim 17, wherein determining the expected number of reads of the first DNA based on the predicted first affinity comprises determining the expected number of reads of the first DNA based on the predicted first affinity and an estimated abundance of the first candidate molecule in the first DEL experiment, and wherein the operations further comprise:
based on the first loss value, updating the estimated abundance of the first candidate molecule in the first DEL experiment;
applying a second graph representing a chemical structure of a second candidate molecule to the predictive model to predict a second affinity of the second candidate molecule for the target;
based on the predicted second affinity and an estimated abundance of the second candidate molecule in a second DEL experiment, determining a second expected number of reads of a second DNA associated with the second candidate molecule expected to be observed in the second DEL experiment;
comparing the determined second expected number of reads to an actual number of reads of the second DNA observed in the second DEL experiment to determine a second loss value for the second candidate molecule; and
based on the second loss value, updating the predictive model.

20. The article of manufacture of claim 19, wherein the operations further comprise:
based on the second loss value, updating the estimated abundance of the second candidate molecule in the second DEL experiment;
based on the updated estimated abundance the of the first candidate molecule in the first DEL experiment and the updated estimated abundance of the second candidate molecule in the second DEL experiment, re-sampling training examples from the first DEL experiment and the second DEL experiment to generate an updated training dataset that is weighted such that a representation of the first candidate molecule in the updated training dataset reflects the updated estimated abundance the of the first candidate molecule in the first DEL experiment and such that a representation of the second candidate molecule in the updated training dataset reflects the updated estimated abundance of the second candidate molecule in the second DEL experiment; and
performing additional updates of the predictive model by training the predictive model using the updated training dataset
